(19) United States
(12) Patent Application Publication
(10) Pub. No.: US 2004/0267388 A1
(43) Pub. Date: Dec. 30, 2004

(54) Method and system for recording and processing of broadcast signals

(75) Inventor: Albert H. Perdon, Cerritos, CA (US)

Correspondence Address: BANNER & WITCOFF, 1001 G STREET N W, SUITE 1100, WASHINGTON, DC, 20001, US

(73) Assignee: Predictive Media Corporation, Cambridge, MA

(21) Appl. No.: 10/606,264

(22) Filed: Jun. 26, 2003

(51) Int. Cl. G06F 17/00

(52) U.S. Cl. 700/94

(57) ABSTRACT

A method and system for allowing a user to listen to audio from any broadcast source and store selected segments to a local storage device for playback or export at a later time. In one form, the method and system allows communication between set top boxes with digital music channels and personal computers to allow the user to store audio from the digital channels to an internal storage medium on the personal computer or store the audio directly on an external storage medium. In one form, the method and system allows the user to identify certain artists, musical styles, or titles of interest and searches the meta-data in a data signal to identify and store the desired audio. The method and system also allow a user to perform trick-play activities on a live broadcast through the use of software that reside locally or remotely to the system.

### FIELD OF THE INVENTION

Aspects of the present invention are directed generally to the field of audio recording systems, and more particularly to recording segments of an audio broadcast source to a storage device and simultaneously permitting tagging and manipulation activities to be conducted on a segment of the audio.

### BACKGROUND OF THE INVENTION

With the inclusion of digital broadcasts, including transmissions over the air, the Internet, digital satellite, and cable television systems, a user has a variety of sources in which to listen to and/or record music. A user need only tune her radio/television/computer/recorder/etc. to a particular broadcast source and instantly receive a variety of different audio signals, including copyright protected signals such as music. Various types of recording systems have been developed to record audio signals from a variety of broadcast sources. Tape players, digital compact disc burners supplied with CD-ROMs with write capability, and computer hard drives are but a few of the recording systems available to users.

Radio stations, Internet developers, digital satellite systems and cable television systems have defined music into certain classified genres for years. Pop, adult contemporary, country, rhythm and blues, rap, hip-hop, jazz, oldies, 70's, 80's, and classical, are but a few of the many different genres of music that industries have focused on. Some broadcast sources only transmit country music, intending to be marketable to a select group of individuals. This level of genre marketing was developed to attempt to place music of interest to groups of people so that a listener of adult contemporary music would be more likely to stay with one station than to switch stations if all that was played was the genre of music that she liked.

Today, a listener of adult contemporary music alone can set a tape player, CD burner, or the hard drive of a computer to record music that is being transmitted from a broadcast source; however, a listener would still be required to listen to everything that was stored in order to find particular music of interest. There are increasing interests in allowing a listener to process and store broadcast signals in order to allow the listener greater flexibility in finding something that the listener is interested in. Indeed, a listener may wish to personalize the audio content she is interested in and to arrange music segments she has recorded to suit her interests. Further, if a listener desired to perform some type of trick-play activity on recorded music such as pausing the music or skipping certain content, a listener may be required to listen to and to have stored the entire song. A user cannot pause a live audio transmission and then play from that point on demand.

### SUMMARY OF THE INVENTION

There is therefore a need to provide methods and systems for allowing a user to personalize audio content reception for storage and to manipulate an audio signal. One aspect of the invention allows reception and decoding of an audio signal from a broadcast data signal, storage of the audio signal, manipulation of the audio signal in response to a user input, and output of the manipulated audio signal. The manipulated audio signal can be output in a linear, e.g., unmodified, or a non-linear, e.g., modified, manner. Another aspect of the invention provides for the addition, identification, and storage for personal use of meta-data associated with an audio signal.

Another aspect of the invention provides for simultaneous storage of an audio signal to a storage device and manipulation of the audio signal on demand, automatically in a predetermined fashion designed by the user, or by a user after recordation. Still another aspect of the invention provides for the programmed operation of user-defined inputs so that recording may be performed automatically and/or via remote control. Another aspect of the invention allows for control over various portions of a device for manipulation of an audio signal. These and other features of the invention will be apparent upon consideration of the following detailed description of illustrative embodiments.

Still another aspect of the present invention provides for searching through various broadcast sources for various audio segments of interest and to record those segments of interest found. Another aspect of the invention allows for storage of the audio segments into various playlists based upon some user-defined and/or automatic priority.

### BRIEF DESCRIPTION OF THE DRAWINGS

The foregoing summary of the invention, as well as the following detailed description of illustrative embodiments, is better understood when read in conjunction with the accompanying drawings, which are included by way of example, and not by way of limitation with regard to the claimed invention.

FIG. 1 is a block diagram of a broadcast signal processing and recording system as known in the prior art;

FIG. 2 is a functional block diagram of an illustrative embodiment of a broadcast and recording system in which certain aspects of the present invention may be implemented;

FIG. 3 is a functional block diagram of an illustrative embodiment of a storage device in which certain aspects of the present invention may be implemented;

FIG. 4 is a schematic diagram of an illustrative embodiment of a user input interface in which certain aspects of the present invention may be implemented;

FIG. 5 is a functional block diagram of an illustrative embodiment of a remotely operated user input interface in which certain aspects of the present invention may be implemented;

FIG. 6 is a functional block diagram of an illustrative embodiment of a broadcast and recording system in which certain aspects of the present invention may be implemented;

FIG. 7 is a functional block diagram of an illustrative embodiment of a broadcast and recording system in which certain aspects of the present invention may be implemented;

FIG. 8 is a functional block diagram of an illustrative embodiment of a broadcast and recording system in which certain aspects of the present invention may be implemented;

FIG. 9 is a functional block diagram of an illustrative embodiment of a broadcast and recording system in which certain aspects of the present invention may be implemented;

FIG. 10 is a flow chart of an illustrative embodiment of a method for allowing a user to manipulate an audio signal in accordance with at least one aspect of the present invention;

FIG. 11 is a flow chart of an illustrative embodiment of a method for recording an audio segment in accordance with at least one aspect of the present invention; and

FIG. 12 is a flow chart of an illustrative embodiment of a method for recording an audio segment in accordance with at least one aspect of the present invention.

### DETAILED DESCRIPTION OF ILLUSTRATIVE EMBODIMENTS

In the following description of various illustrative embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope of the present invention.

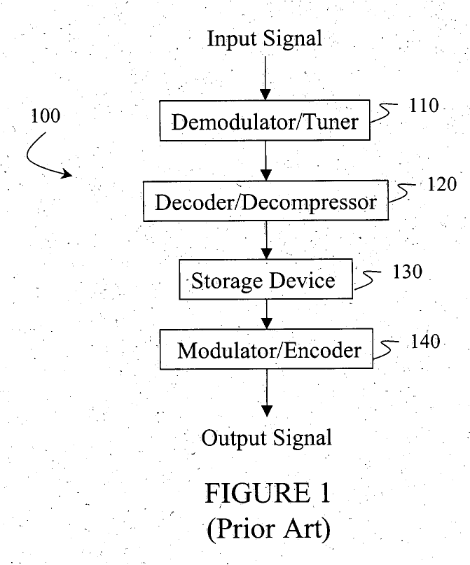

FIG. 1 shows a conventional signal processing and recordation system 100 as is known on the art. Conventional signal processing and recordation system 100 includes a demodulator/tuner 110, a decoder/decompressor 120, a storage device 130, and a modulator/encoder 140. A conventional signal processing recordation system 100 receipts and input signal and a demodulator/tuner 110. Demodulator/tuner 110 tunes to and/or demodulates the received input signal from any one of a number of sources including, but not limited to radio frequency transmission, Internet broadcast transmissions, Internet radio frequency transmissions, digital satellite transmissions, digital cable transmissions, and optical fiber transmissions. The demodulated signal is then sent to decoder/decompressor 120. Decoder/decompressor 120 decodes the input signal to its elementary signal components. Typically, the user selectively sends the decoded signal to a storage device 130 if the user desires to record the signal. Storage device 130 can be any of a variety of storage devices known in the art, including, but not limited to random access memory (RAM), read only memory (ROM), electronically eraseable programmable read only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed. The user may choose to manually manipulate or output the record signal. At a subsequent time, for example, the stored signal can be demodulated and/or encoded by a modulator/encoder 140 selectively and output.

Conventional signal processing and recordation system 100 fails to allow a user to personalize recorded content or perform activities on a live broadcast audio signal. Any type of manipulation of the signal occurs after the audio signal has been completely stored. A user does not have the capability to simultaneously store the audio signal and to manipulate the audio signal to be outputted.

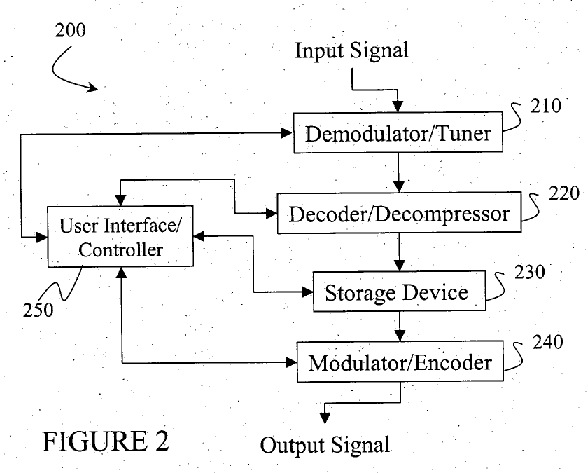

FIG. 2 is an illustrative embodiment of a signal processing and recordation system 200 according to at least one aspect of the present invention. The signal processing and recordation system 200 includes a demodulator/tuner 210, a decoder/decompressor 220, a storage device 230, and demodulator/encoder 240. The signal processing and recordation system 200 further includes a user interface/controller 250. The input signal may be packet based or serial based. Demodulator/tuner 210 that can be any of a variety of different devices. Demodulator/tuner 210 may include a radio frequency tuner that receives a transmission via the Internet, from a cable TV coaxial cable, satellite radio, or a broadcast radio frequency aerial transmission. The radio frequency tuner can receive the data signal via electromagnetic radio wave transmission over the carryover wire or through the air. For Internet reception, demodulator/tuner 210 may further include an IP network interface that receives a transmission from an Internet twisted pair, a wireless interface or other IP medium that receives a transmission from an Internet source and/or, an optical receiver that receives a transmission from an Internet fiber or through the air. These are but some examples of demodulator/tuner 210, and it should be understood by the skilled in the art that other demodulator/tuner devices may be utilized and the present invention is not so limited.

Decoder/decompressor 220 may include any device that can decode a broadcast data signal into its elementary signals. A typical decoder/decompressor 220 decodes an audio signal from a broadcast data signal. Decoder/decompressor 220 can also separate encoded and/or compressed MPEG data from the broadcast data signal and decode and/or decompress the MPEG data. Storage device 230 may be any of a variety of devices that can store/record signals. Storage device 230 may include a hard drive on a personal computer, a compact disc read only memory, and a random access memory. Storage device 230 may store audio signals in either a digital or analog manner. Further, multiple storage devices 230 may be used in which some store audio signals in a digital manner while other store audio signals in analog manner.

Storage device 230 may also store meta-data about the decoded audio signal received in the manner such submitted data can be associated with either the entire recorded audio signal, segments of the recorded audio signal, or segments of the audio signal that were not record. Meta-data, for example, may identify the source of the signal and typically comprises identity of title, track, artist, and other copyright/watermarking data. The meta-data is typically encoded and encrypted in a manner so that it may be selectively utilized by those authorized to receive it. Storage device 230 may be configured to provide multiple synchronous and asynchronous data access. Further, storage device 230 may allow simultaneous writing and reading of any number of audio signals. During such event, the current audio signal is simultaneously being written to and read from, either alone or with other audio signals, the storage device 230. Such a configuration of a storage device 230 permits a user to manipulate an audio signal on demand, e.g., a user can pause a live broadcast signal and continue to play from that paused point at a later time.

Modulator/encoder 240 may include any device that can modulate, encode, and/or convert an audio signal. Although not shown in FIG. 2, modulator/encoder 240 may receive the audio signal directly from decoder/decompressor 220. Modulator/encoder 240 may also be configured to output the audio signal, whether manipulated or directly from the demodulator/tuner 220, to any of a number of devices. Modulator/encoder 240 may output to a pre-amplifier analog device, an amplifier, a digital audio device, a set of speakers or headphones, network devices, another storage device external to the system, and/or a digital data device. The outputted audio signal could be in, analog format or the signal could be encoded or compressed. The listing of possible output devices is but an illustration of the different types of output device and the present invention is not so limited. Further, modulator/encoder 240 may read a single or multiple audio signals from a storage device 230 in a linear or non-linear manner.

User interface/controller 250 is capable of controlling each component of the signal processing and recording system 200. User interface/controller 250 is operatively coupled to the demodulator/tuner 210, the decoder 220, the storage device 230, and the modulator/encoder 240. User interface/controller 250 controls the flow of the audio signal in any of a number of different manners. Because the user interface/controller 250 has the capability to control the function of each component of the system 200, a user can manipulate an audio signal at any time or point. User interface/controller 250 allows the audio signal to be outputted in a live mode or in a delayed mode. User interface/controller 250 can cause the output of an audio signal to be paused while simultaneously storing the live broadcast signal. In one example, a user can pause the output of a particular musical recording and then unpause, i.e., continue playing from the same point, the musical recording. As segments of audio signals are stored in the storage device 230, user interface/controller 250 allows a user and/or the system to select which segments to keep, which segments to play, which segments to delete, and/or which segments to output either automatically or in response to a user input.

For example, a user may create a playlist for the system 200 to record a particular song by a particular artist if found on any broadcast source signal. The user can input, in the user interface/controller 250, a priority scale. For this example, the user may want to first get a recording from a digital cable source as that may be the quality source that the user prefers. Alternatively, the user may want a recording of the particular song from any source available if the digital cable source never plays the particular song. Further, the user may enter an operational command to output the particular song immediately to a set of speakers if the particular song is found in any broadcast source. Therefore, if the particular song is found on an Internet source, the user interface/controller 250 will output the particular song to a set of speakers and will record the particular song. If, at a later time or concurrently, the particular song is found on a digital cable source, user interface/controller 250 can overwrite the previously recorded or concurrently recorded particular song in the storage device 230. Alternatively, it can record the particular song from each source separately and await user input to determine which copy to keep and/or which copy to delete. Various other methods for recording, storage, and/or priority are understood by those skilled in the art.

User interface/controller 250 also allows for a user to insert bookmarks or markers anywhere in an audio segment by use of meta-data. The meta-data associated with an audio segment may be edited by user interface/controller 250. User interface/controller 250 further allows a user to search through and/or list audio segments stored within a storage device, such as storage device 230. Meta-data associated with each audio segment can be read and searched by any of a number of different criteria. For example, a user may search for audio segments written and/or performed by an artist of interest, audio segments that are less than five minutes in length, and/or audio segments that include a certain amount of bass. In an alternative embodiment, user interface/controller 250 may record and compare voice printing of the artist, strings of words from the lyrics of a particular audio segment, or other indicia of a desired audio segment to determine if the audio segment of desired length is to be recorded at the request of the user.

User interface/controller 250 may be of any of a variety of different devices. User interface/controller 250 may include a graphical user interface and/or a remote control to allow a user to input certain functions. Further, user interface/controller 250 may include a display and/or speaker to output information in response to a user input or automatically. Operation of user interface/controller 250 may be conducted by microprocessor controlled hardware, microprocessor controlled software, or a combination of the two. As stated, manipulation of the audio signal is performed by the user interface/controller 250. As will be further described, user interface/controller 250 allows a user to perform activities on an audio signal. Many of these activities are known as trick-play activities. Some of the activities that the user interface/controller 250 can perform include, rewind, pause, fast forward, skip, re-play, and reverse. Specific functions of each are more fully described below. System 200 is designed to operate in any of a number of different system including operation within a single unit for personal use in a vehicle, such as a car or boat, or operation within a single unit, such as a portable electronic device.

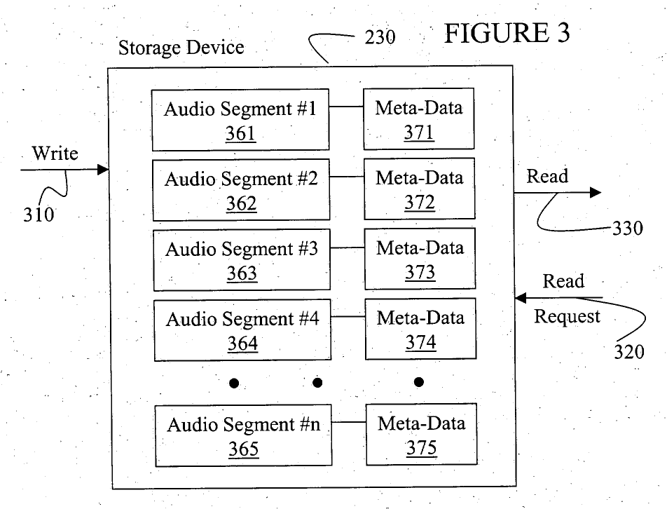

FIG. 3 is a functional block diagram of an illustrative embodiment of a storage device 230 in accordance with at least one aspect of the present invention. Storage device 230 may store/record audio signals and audio signal information in a number of different manners. FIG. 3 is but one illustrative embodiment. Storage device 230 is shown in FIG. 3 to include a number of audio segments and associated meta-data. Storage device 230 includes audio segment #1 361 with an associated meta-data 371 such as song title, audio segment #2 362 with an associated meta-data 372 such as artist identity, audio segment #3 363 with an associated meta-data 373 such as release date for the song, audio segment #4 364 with an associated meta-data 374, and audio segment #n ˜365 with an associated meta-data 375. Also as described above, voiceprints, strings of words recorded from a desired audio segment and the like may similarly be input to aid in audio segment selection for recording. Any number of audio segments and associated meta-data files and other data may be stored in storage device 230. The number of segments and files that may be stored is only limited to the capacity of the storage device 230.

Storage device 230 may also include a playlist criteria for stored audio segments. For example, a user may have an audio list so that certain songs are placed into a playlists in a particular location. A user may wish to store the particular songs in a predefined order. Storage 230 can accommodate the user permitting a user to define the order in which some or all songs are stored. A user may wish to store songs by a particular artist in the order in which they were released, or alphabetically, or by the tempo of the song. Many different criteria for playlists may be utilized and these are but a few options available.

FIG. 3 shows a write 310 representative of a write command to the storage device 230 to record/store an audio segment and/or meta-data file. Further, a read request 320 and read 330 are shown in FIG. 3. User interface/controller 250 may request, via a read request 320, to read a particular audio segment, multiple audio segments, and/or meta-data associated with audio segments. Upon receipt of the read request 320, the storage device 230 will read out 330 the requested information. One embodiment of the present invention permits a user to simultaneously write to and read from a storage device 230. For example, in such a situation, as an audio signal is being written to the storage device 230, the same audio file, a different audio file, or a multitude of audio files including the same audio file may be read out to a modulator/encoder 240. Simultaneously reading and writing capability of the storage device 230 permits a user to manipulate a live broadcast signal on demand. A user can pause a song, wait a certain time period, and then resume play of the song from the same location. Further, a user could manipulate the song to slow the song down or re-play the song from the beginning on demand.

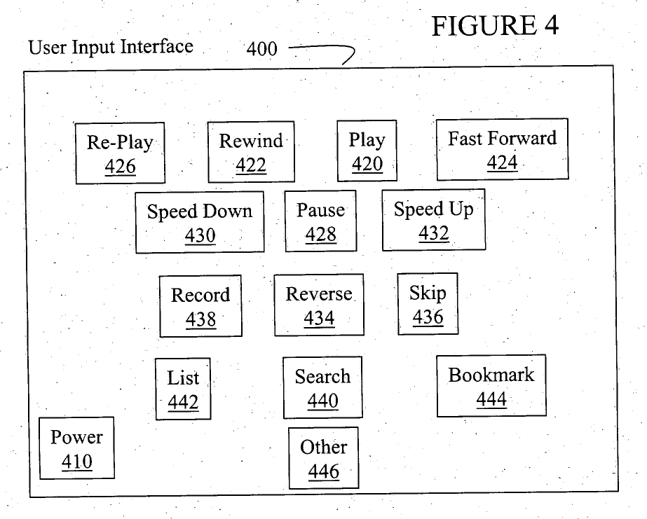

FIG. 4 is a functional block diagram of an illustrative embodiment of a user input interface 400 in accordance with at least one aspect of he present invention. User input interface 400 may be a graphical user interface included within user interface/controller 250. User input interface 400 may include a liquid crystal display or light emitting diode display, among other types. Further, user input interface 400 may be included within a liquid crystal display or cathode ray tube display connected external to other components and devices of the system.

As shown in FIG. 4, user input interface 400 includes a number of different inputs that a user can activate in order to manipulate an audio signal and/or audio segment. User input interface may include a power activation switch 410 to turn on the user input interface 400 and/or the entire system, including any or all other components such as the demodulator/timer 210, the decoder 220, the storage device 230, and the modulator/encoder 240. User input interface 400 further includes a play activation switch 420 to play a certain audio signal, a rewind activation switch 422 and fast forward activation switch 424 to rewind or fast forward through the audio signal, and a re-play activation switch 426 to re-play the audio signal. As the audio signal may be a particular song, the re-play activation switch 426 permits a listener to hear the same song again.

User input interface 400 may also include a pause activation switch 428, a speed down activation switch 430 and a speed up activation switch 434. Speed down and speed up functions merely change the output rate in which an audio signal is outputted, whether slower or faster than a normal speed. Additional activation switches include a reverse switch 434, a skip switch 436, and a record switch 438. Activation of reverse switch 434 outputs the audio signal and/or segment in a reverse manner than, is outputted in normal mode, such as with activation of the play switch 420. Skip switch 436 may be programmed to bypass a particular segment, e.g., song, to start on the next segment, i.e., song. Skip switch 436 may also be programmed to bypass a particular length of a segment, e.g., thirty (30) seconds. Further, both capabilities, whether automatic or preprogrammed by a user, may exist as switches on the user input interface 400. Activation of the record switch 438 records the outputted audio signal to some type of storage device. Any of these switches may be activated alone or in conjunction with another switches or switches. For example, a user may activate switches 432 and 438 to record a sped up version of an audio signal and/or segment, e.g., song.

User input interface 400 further includes an activation switch 440 to search meta-data associated with various audio segments in a storage device 230. A user can search to find a particular segment/s of interest by searching for a particular genre, a particular musical group, a particular song, and/or some other criteria, such as a particular talk radio host or show. Activation of list switch 442 may display a listing of all or a portion of stored audio segments in a storage device 230. Portions of the stored segments may be by genre or some other type of category. Bookmark switch 444 allows a user to insert a bookmark into an audio signal and/or segment. A bookmark may include additional information included within the meta-data and/or a revision of the meta-data associated with a particular audio segment. Finally, the other switch 446 includes other functions that may be performed to manipulate an audio signal and/or segment. For example, other switch 446 may activate an information screen giving information about the current audio signal, such as length of time remaining in the segment. Other features include tuning capabilities to tune to a particular station, website, and/or channel.

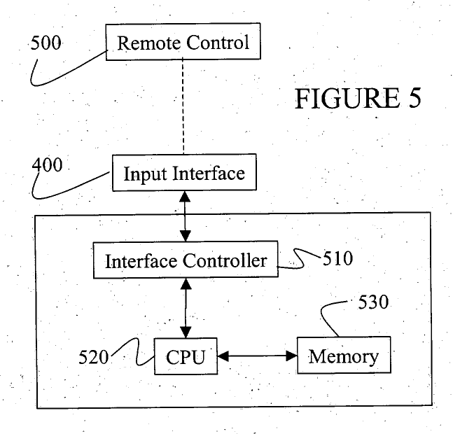

FIG. 5 is an illustrative embodiment of a remote control operated user input interface 400 in accordance with at least one aspect of the present invention. User input interface 400 may be directly or distally connected to an interface controller 510, which is coupled to a microprocessor 520, which in turn is coupled to a memory 530. Memory 530 may contain operating instructions to perform the functions available with the user input interface 400. These operating instructions are utilized by the microprocessor 520 to control the other components of the signal recording and processing system as is described below. The same functions available in the user input interface 400 may be activated by a signal sent, via infrared, radio frequency, cellular transmission, etc. from a remote control device 500. Remote control 500 may include the same activation switches as those shown in FIG. 4. In an alternative embodiment, remote control 500 may include directional buttons allowing a user to move around a display, such as the display of FIG. 4, and activate a highlighted switch. Remote control 500 may be any of a number of types of communication devices. In one embodiment, remote control 500 may be a cellular telephone. With the advancements in cellular telephone technology, a user's cellular phone may be used to control and/or communicate with user input interface 400. A user can enter specific information to the user input interface 400 via the cellular telephone.

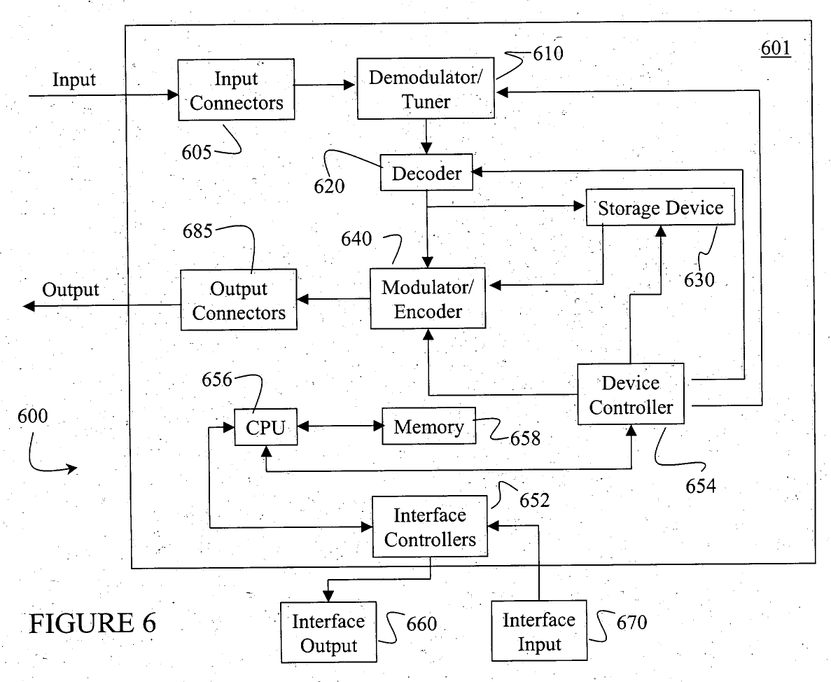

FIG. 6 is a functional block diagram of an illustrative embodiment of a signal recording and processing system 600 in accordance with at least one aspect of the present invention. System 600 comprises a unit 601. Unit 601 could be a portable electronic device, such as a personal digital assistant or a portable music player, or unit 601 could be included within a vehicle of a user, such as a user's car or boat to record songs while in transit. Unit 601 includes input connectors 605. Input connectors 605 enable the unit 601 to be connected to any number of data sources, such as a network connection, a fiber optic source, a wireless data source, and/or a broadcast television feed. Input connectors 605 may include connections to an optical receiver, a wireless radio frequency tuner, a network interface, and/or an aerial radio frequency tuner. The input connectors 605 pass the input signal to a demodulator/tuner 610. Demodulator/tuner 610 demodulates and/or tunes the input signal received from the data sources. Decoder 620 decodes the input signal to elementary signal components, including an audio signal. If the data was MPEG encoded and/or compressed, the decoder could separate the data streams and decode and/or decompress the data according to inputs received from a user and/or automatically. The audio signal may then be stored in a storage device 630 and/or sent directly to a modulator/encoder 640. The audio signal is buffered to allow the user to listen to a live version of the audio transmission.

The system 600 would also allow the user to listen to a live version of the audio transmission while simultaneously storing the signal to permit a user to perform activities, such as trick-play activities, on the audio signal. A user could pause the live broadcast or signal and slow-down on demand. The modulator/encoder 640 can modulate and/or encode the audio signal and then outputs the audio signal to output connectors 685. Output connectors 685 may include connections to an optical transmitter, a network interface, a USB, a pre-amplifier analog device, an amplifier, headphones, speakers, and/or a digital audio device. Output connectors ultimately output the audio signal out of the unit 601. Output of the audio signal front the system or from individual components may be linear or non-linear in manner. It should be understood by those skilled in the art that the term “linear” is used herein to mean that the audio segment, as output or stored, is the same as it was received and the term “non-linear” is used herein to mean that the audio segment, as output or stored, has been changed in some manner from the way in which it was received.

Control of the demodulator/tuner 610, decoder 620, storage device 630, and modulator/encoder 640 is performed by the device controller 654. Device controller 654 is operatively coupled to a microprocessor 656. A real time clock (not shown) can be operatively connected to and/or included within the CPU 656 and/or device controller 654. Memory 658 includes operating instructions for the microprocessor 656 to perform user activated functions received from user interface controller 652. The microprocessor 656 and device controller 654 control the manipulation of audio signals read from the storage device 630 and/or sent directly to the modulator/encoder 640. When a user activates an activation switch by an interface input 670, user interface controller 652 transmits the identification of the function to be performed to the microprocessor 656. Information and or other data may be sent to the user via interface output 660, such as an acknowledgement that an activation function was initiated or a listing of current segments stored within the storage device 630.

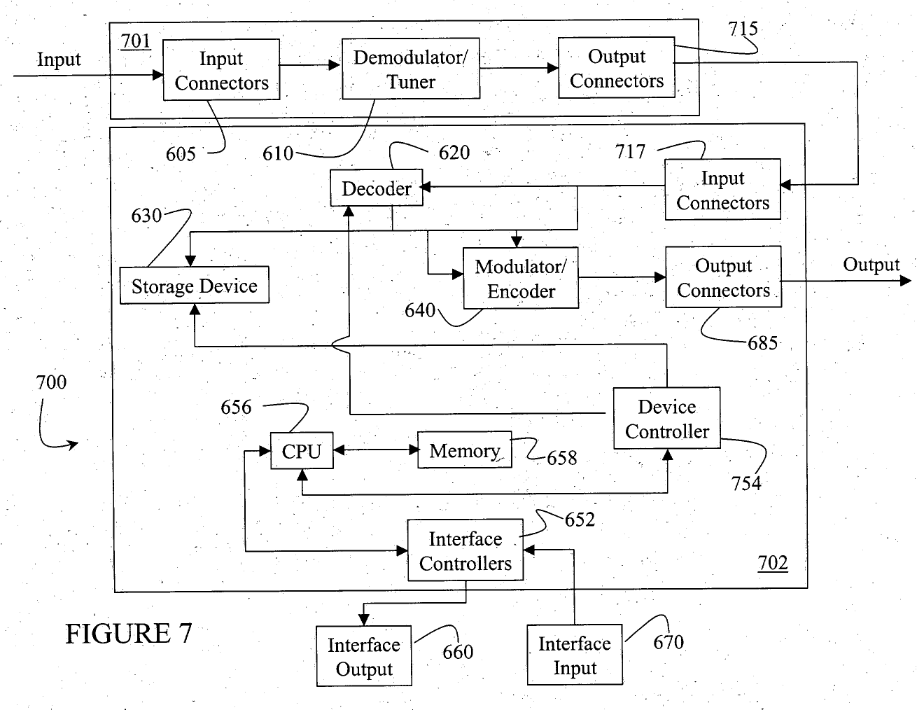

FIG. 7 is a functional block diagram of an illustrative embodiment of a signal recording and processing system 700 in accordance with at least one aspect of the present invention. System 700 performs similar operations to those described with reference to FIG. 6. System 700 includes: two units, unit 701 and unit 702. System 700 is an illustrative embodiment in which two separate devices, e.g., units 701 and 702, can communicate with each other in a cooperative manner to perform the same functions as those illustrated in FIG. 6. Unit 701 may be a device such as a set-top box that contains the input connectors 605 and demodulator/tuner 610. Unit 702 may be a personal computer or portable computer device. Unit 701 has output connectors 715 that are coupled to the input connectors 717 of unit 702. By using these connectors, unit 701 can communicate to unit 702 via a USB cable, a serial cable, a radio frequency connection, a fiber connection, and/or a network connection.

Unit 702 includes the decoder 620, storage device 630, modulator/encoder 640, output connectors 685, microprocessor 656, memory 658, and user interface controllers 652. Unit 702 further includes device controller 754. Device controller 754 is shown to control the operation of the decoder 620 and storage device 630. A real time clock (not shown) can be operatively connected to and/or included within the CPU 656 and/or device controller 754. Although not shown in FIG. 7, device controller 754 could be configured to control the operation of the demodulator/tuner 610 in unit 701. Software could be utilized in both unit 701 and unit 702 and graphical user interfaces could be utilized on both units 701 and 702. Unit 701 could have a user interface device associated with it, such as a remote control that would allow a user to interact with the system 700 and control operation of the system 700 via screen menus. Unit 702 could have a mouse, joystick, trackball, keyboard, and/or remote control that would allow a user to interact with the system 700 to control operation of the system 700 via on screen menus. A user could access the meta-data associated with audio segments stored within the storage device 630 via unit 701 or unit 702 for the purpose of editing the meta-data or searching through the meta-data. In addition, although not shown, both units 701 and 702 could have the ability to output an audio segment of interest to different output connections for delivery to the user. Unit 701 may be configured to output an audio signal to a television and/or speakers, while unit 702 could be configured to output an audio signal to speakers; another computer, or to a separate storage device, such as a tape or CD-ROM.

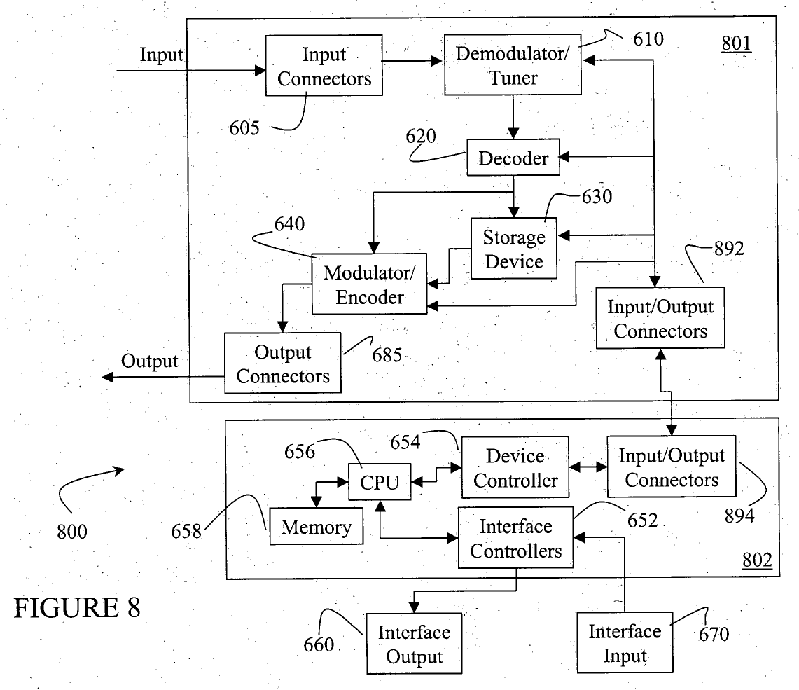

FIG. 8 is a functional block diagram of an illustrative embodiment of a signal recording and processing system 800 in accordance with at least one aspect of the present invention. System 800 performs similar operations to those described with reference to FIGS. 6 and 7. System 800 includes two units, unit 801 and unit 802. System 800 is an illustrative embodiment in which two separate devices, e.g., units 801 and 802, can communicate with each other in a cooperative manner to perform the same functions as those illustrated in FIGS. 6 and 7. Unit 801 may be a device such as a set-top box that contains the input connectors 605, demodulator/tuner 610, decoder 620, storage device 630, modulator/encoder 640 and output connectors 685. Unit 802 may be a personal computer or portable computer device. Unit 802 includes device controller 654, microprocessor 656, memory 658, and interface controllers 654. A real time clock (not shown) can be operatively connected to and/or included within the CPU 656 and/or device controller 654. Units 801′ and 802 can communicate with each other via input/output connectors 892 and 894. Via input/output connectors 892 and 894, device controller 654 can control the operation of demodulator/tuner 610, decoder 620, storage device 630, and modulator/encoder 640. The controlling software could reside within unit 801, unit 802, or both units.

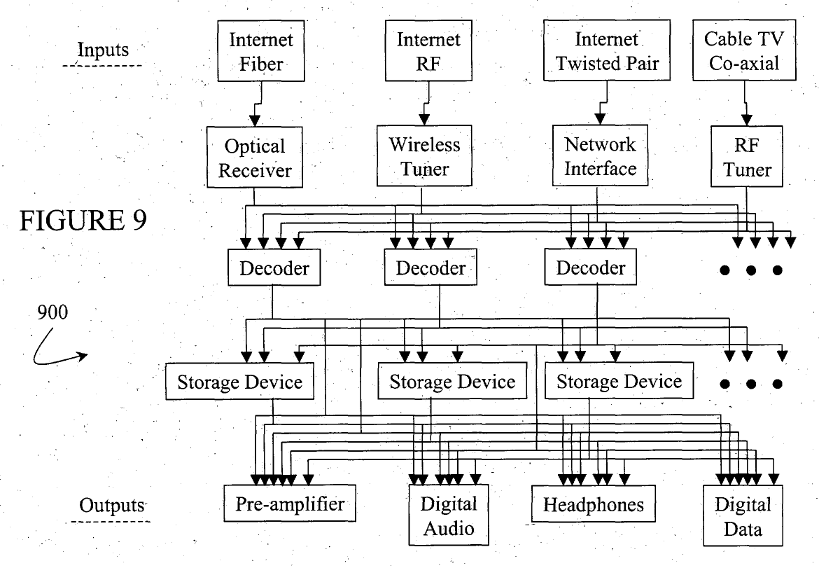

FIG. 9 is a functional block diagram of an illustrative embodiment of a broadcast and recording system 900 in accordance with at least one aspect of the present invention. FIG. 9 is an illustrative schematic of multiple data sources being connected to the signal recording and processing system 900. Signals from multiple data sources can be received by the system 900 and stored in multiple storage devices before output to multiple types of output devices.

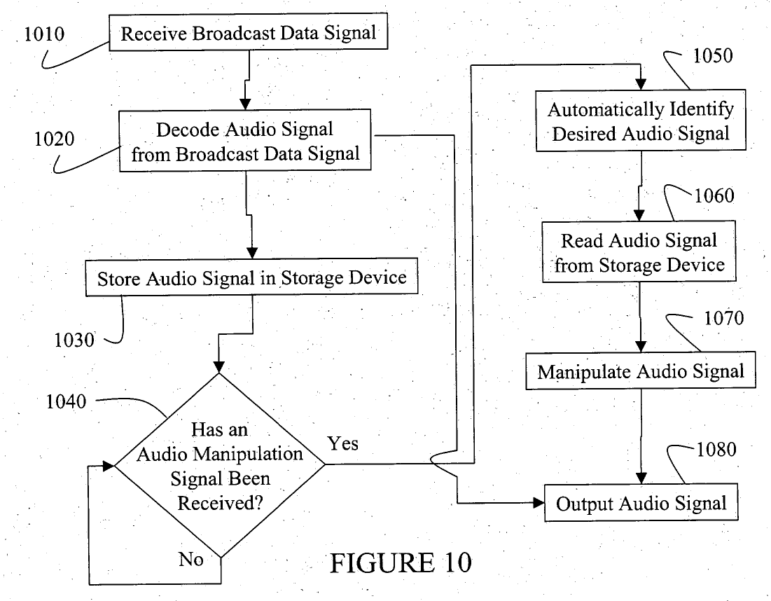

FIG. 10 is a flow chart of an illustrative embodiment of a method for allowing a user to manipulate an audio signal in accordance with at least one aspect of the present invention. The process begins at step 1010 where a broadcast data signal is received by the system. At step 1020, the audio signal is decoded from the broadcast signal. The audio signal may then be simultaneously transmitted to step 1080 where the audio signal is outputted and to step 1030 where the audio signal is stored in a storage device. Step 1020, 1030, and 1080 allow a user to simultaneously listen to a live broadcast and manipulate the live broadcast signal.

At step 1040, a determination is made as to whether an audio manipulation signal has been received. An audio manipulation signal could be any of a variety of signals that a user has inputted and/or the system has automatically activated for an audio signal. If an audio manipulation signal has not been received, the process waits until an audio manipulation signal is received. In the case where an audio manipulation signal has been received, automatic identification of the desired audio signal is made at step 1050. For example, this may be the identification of a particular song of interest among the audio segments stored within a storage device. At step 1060, the identified audio signal is read from the storage device. In response to a user input, at step 1070, the audio signal is manipulated as necessary, and the signal is finally outputted at step 1080.

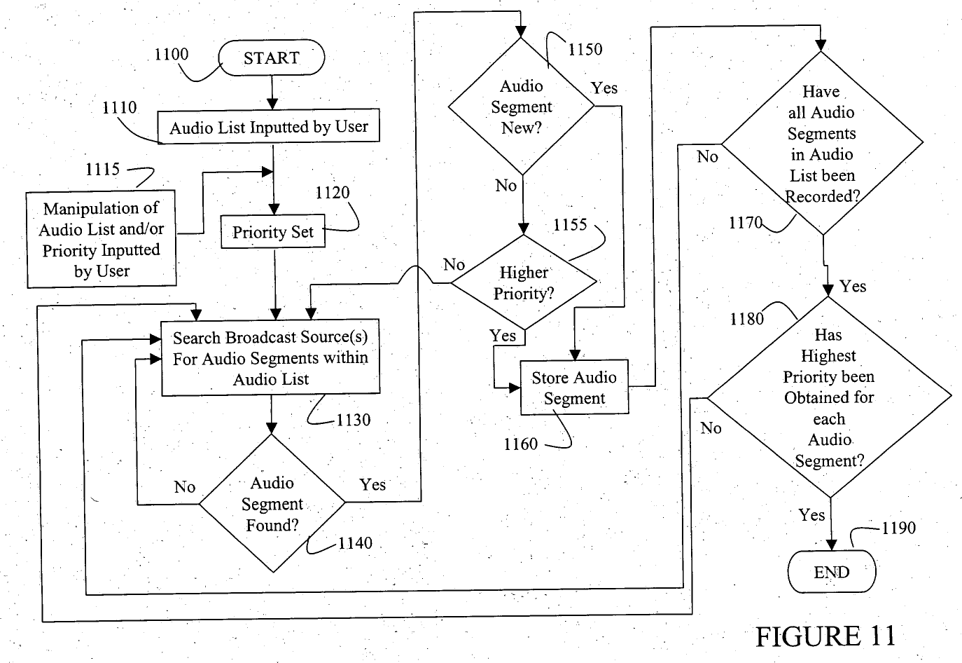

FIG. 11 is a flow chart of an illustrative embodiment of a method for recording an audio segment in accordance with at least one aspect of the present invention. The process begins at step 1100. At step 1110, an audio list is inputted by a user. A user may enter her audio list directly via the user interface/controller 400 and/or she may enter the audio list via remote control 500. User interface/controller 400 and/or remote control 500 may include a keyboard entry system for inputting an audio list. Alternatively, user interface/controller 400 and/or remote control 500 may include a touchpad system allowing for entry via a stylus. Any of a number Of different technologies may be utilized, for entry of an audio list. Further, the audio list may include listing of song titles, artist or band information, strings of words from lyrics of a song, a release date of a song, and any of a number of additional indicia of a type of audio segment that is desired by the user.

At step 1115, manipulation of the audio list and/or priority is inputted by the user. Step 1115 is optional and merely allows a user to modify audio segments from her list and/or modify the priority of recording audio segments within the audio list, Step 1115 permits a user to enter an additional song to the audio list at a later time, or to remove a song. Other types of modifications are permitted in this step and these are but a few illustrations. At step 1120, a priority is set for recording the audio segments in the audio list. This priority may include which broadcast source the user would like to record from over another broadcast source. Therefore, if a song in the audio list is broadcast over one medium, if the same song is broadcast later over a second medium with a higher priority, it will be recorded as well.

With the audio list inputted and priority established, the process moves to step 1130 where the system searches broadcast source(s) for audio segments that match audio segments within the user inputted audio list. At step 1140, a determination is made to whether an audio segments has been found that matches a desired audio segment within the audio list. If not, the process continues to search for audio segments at step 1130. If a match is found, a determination is made, at step 1150, to whether the found audio segment is new, i.e., the found audio segment matches a desired audio segment in the audio list and has not been previously or is not currently being recorded by the system. If the found audio segment is not new, a determination is made at step 1155 to whether the found audio segment has a higher priority than the previously or currently recorded audio segment. In this step, the found audio segment may be received from a broadcast source that is preferred by the user over another broadcast source, therefore it has a higher priority. If the found audio segment does not have a higher priority, the process returns to step 1130.

If the found audio segment is new or has a higher priority, the process moves to step 1160 where the found audio segment is stored, such as in storage device 230. The process then moves to step 1170 where a determination is made to whether all audio segments within the user inputted audio list have been recorded. If all audio segments have not been recorded, the process returns to step 1130 to continue searching for matching audio segments. If all audio segments have been recorded, the process moves to step 1180. In step 1180, a determination is made to whether the highest priority has been obtained for each audio segment in the user inputted audio list. If the highest priority level has not been obtained for each audio segment, the process returns to step 1130. If all the audio segments have been recorded to the desired priority level, the process is complete at step 1190.

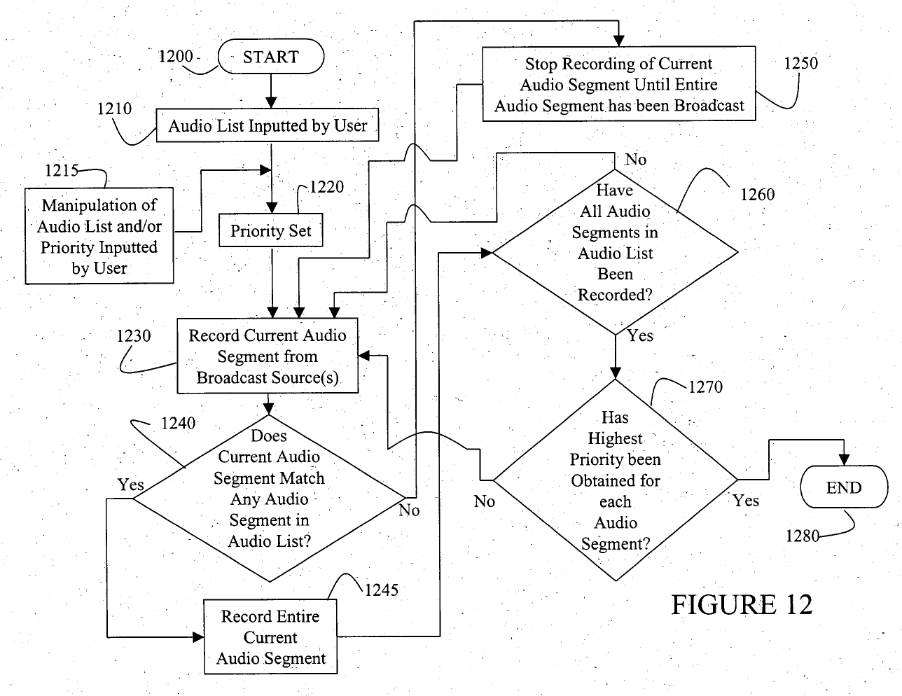

FIG. 12 is a flow chart of another illustrative embodiment of a method for recording an audio segment in accordance with at least one aspect of the present invention. The process begins at step 1200. At step 1210, an audio list is inputted by a user. At step 1215, manipulation of the audio list and/or priority is inputted by the user. As similarly with reference to step 1115 in FIG. 11, step 1215 is optional and merely allows a user to modify audio segments from her list and/or modify the priority of recording audio segments within the audio list. At step 1220, a priority is set for recording the audio segments in the audio list. With the audio list inputted and priority established, the process moves to step 1230.

At step 1230, the current audio segment from a broadcast source(s) is recorded. Step 1230 allows for multiple recordings to occur at one time and the following description is limited to a single broadcast source for illustrative purposes only. At step 1240, a determination is made to whether the current audio segment being recorded matches any audio segment in the user inputted audio list. As previously stated, this determination made be made by the system based upon meta-data found within the broadcast signal that includes the title of the audio segment, the artist or band name, or other information. Strings of words from the song and/or the voice print of a singer of the song may be analyzed to determine whether a match has occurred. Voice print recognition technology and other technology exists for analyzing meta-data are well known by those skilled in the art.

If the current audio segment does not match a desired audio segment in the audio list, at step 1250, recordation of the current audio segment is stopped until the entire current audio segment has been broadcast and a new audio segment is broadcast and the process begins again at step 1230. If the current audio segment matches a desired audio segment in the audio list, at step 1245, recording of the current audio segment is continued until the entire current audio segment has been recorded. The process then continues at step 1260 where a determination is made to whether all audio segments within the user inputted audio list have been recorded. If all audio segments have not been recorded, the process returns to step 1230 to continue recording audio segments. If all audio segments have been recorded, the process moves to step 1270. In step 1270, a determination is made to whether the highest priority has been obtained for each audio segment in the user inputted audio list. If the highest priority level has not been obtained for each audio segment, the process returns to step 1230. If all the audio segments have been recorded to the desired priority level, the process is complete at step 1280.

An illustrative example of the present invention follows. A user of the present system may decide to record all songs by a particular band, such as “Band X”. A user can input an audio list into the system to record any song by “Band X” that is broadcast from any broadcast source. This audio list can be entered by merely typing in the search criteria of “Artist Name: Band X” into the system. Further, a user can specify that songs from an Internet broadcast source are desired more, i.e., have a higher priority, than songs from other broadcast sources. The system will now search meta-data in a single or multiple broadcast sources to search for any song that is performed by “Band X.” Once a match is found by the system, the entire audio segment is recorded. The system will continue to monitor broadcast sources for songs performed by “Band X”. Later in the day, the user may return to the system and find that seven songs performed by “Band X” have been recorded for her. She may then play those songs and/or download them to another recordable medium, such as a CD-ROM. Other embodiments include playing a song by “Band X” immediately as it is broadcast so that the system can send the song to a set of speakers for the user to listen to immediately. Still other embodiments allow the user to interface with the system to modify any aspect of the operation of recordation. A user can add new search criteria, modify existing search criteria, change priority levels, delete recorded songs, etc. via a remote control device.

While illustrative systems and methods as described herein embodying various aspects of the present invention are shown, it will be understood by those skilled in the art, that the invention is not limited to these embodiments. Modifications may be made by those skilled in the art, particularly in light of the foregoing teachings. For example, each of the elements of the aforementioned embodiments may be utilized alone or in combination or subcombination with elements of the other embodiments. It will also be appreciated and understood that modifications may be made without departing from the true spirit and scope of the present invention. The description is thus to be regarded as illustrative instead of restrictive on the present invention.

I claim:

1. A method for recording and manipulating an audio signal comprising steps of:
receiving a list of audio segments;
receiving a broadcast data signal, the broadcast data signal including an encoded audio signal;
decoding the audio signal from the broadcast data signal;
determining whether meta-data in the audio signal matches an entry within the list of audio segments;
automatically recoding the audio signal;
determining whether an audio manipulation signal is received;
automatically identifying at least one segment of the audio signal responsive to the audio manipulation signal;
reading the at least one segment of the audio signal;
manipulating the at least one segment of the audio signal responsive to receipt of the audio manipulation signal; and
outputting the manipulated audio signal.

2. A method for allowing a user to manipulate an audio signal, the method comprising steps of:
receiving a broadcast data signal, the broadcast data signal including an encoded audio signal;
decoding the audio signal from the broadcast data signal;
storing the audio signal;
determining whether an audio manipulation signal is received;
automatically identifying at least one segment of the audio signal responsive to the audio manipulation signal;
reading the at least one segment of the audio signal;
manipulating the at least one segment of the audio signal responsive to receipt of the audio manipulation signal; and
outputting the manipulated audio signal.

3. The method of claim 2, further comprising a step of encoding the audio signal prior to the step of storing.

4. The method of claim 2, wherein the manipulated audio output signal is outputted in a linear manner.

5. The method of claim 2, wherein the manipulated audio output signal is outputted in a non-linear manner.

6. The method of claim 2, wherein the audio manipulation signal is representative of a request to identify a type of meta-data in the audio signal.

7. A system for manipulating an audio signal comprises:
a receiver configured to receive a broadcast data signal, the broadcast data signal including an encoded audio signal;
a decoder configured to decode the audio signal from the broadcast data signal;
a storage device configured to store the audio signal;
a user interface configured to receive an audio manipulation signal from a user;
a controller configured to control the receiver, the decoder, and the storage device;
a processor configured to manipulate at least one segment of the audio signal in response to the audio manipulation signal; and
an output device configured to output the manipulated audio signal.

8. The system of claim 7, wherein the storage device is configured to store the audio signal in a non-linear manner.

9. The system of claim 7, wherein the user interface is remotely operated.

10. The system of claim 7, wherein the controller is one of: a microprocessor controlled hardware, a software controlled hardware, and a combination of a microprocessor controlled hardware and a software controlled hardware.

11. The system of claim 7, wherein the receiver comprises one of: a radio frequency tunable device, a tunable optical device, and a digital network interface device.

12. The system of claim 7, wherein the decoder is configured to decode the audio signal.

13. The system of claim 7, wherein the decoder is configured to decompress the audio signal.

14. The system of claim 7, wherein the storage device is configured to store meta-data associated with one of: the stored audio signal, a segment of the recoded audio signal, and a segment of the unstored audio signal.

15. The system of claim 14, wherein the meta-data is configured to be edited.

16. The system of claim 7, wherein the storage device is configured to provide simultaneous writing of the audio signal and reading of the audio signal.

17. The system of claim 7, wherein the processor is configured to read multiple audio signals from the storage device simultaneously.

18. The system of claim 7, wherein the processor is configured to read the audio signal from the storage device in a non-linear manner.

19. The system of claim 7, wherein the processor is configured to directly receive the audio signal from the decoder.

20. An apparatus for processing a broadcast audio signal comprises:
a receiver configured to receive a broadcast audio signal;
a controller configured to pass the broadcast audio signal in both a linear and non-linear manner;
a storage device configured to store the broadcast audio signal;
a processor configured to manipulate at least one segment of the broadcast audio signal in response to an audio manipulation signal; and
an output connector configured to output the manipulated audio signal.

21. An apparatus for processing an audio signal comprises:
a demodulator configured to demodulate a broadcast data signal;
a decoder configured to decode an audio signal from the broadcast data signal;
a storage device configured to store the audio signal;
a modulator configured to modulate the audio signal;
a controller configured to control the decoder, the storage device, and the modulator;
a processor, coupled to the controller, configured to manipulate the audio signal;
a memory configured to store computer-readable instructions to operate the processor;
a user interface configured to receive an audio manipulation signal; and
an output connector configured to output the audio signal.

22. The apparatus of claim 21, wherein the controller is configured to control the demodulator.

23. The apparatus of claim 21, wherein the controller is configured to control the decoder, the storage device, and the modulator remotely.

24. A method for recording an audio segment comprising steps of:
receiving a list of audio segments;
automatically searching a broadcast source;
determining whether an audio segment in the broadcast source matches an entry within the list of audio segments; and
automatically recording the audio segment.

25. The method of claim 24, further comprising a step of receiving a priority criteria.

26. The method of claim 25, further comprising steps of:
determining whether the audio segment is new; and
determining whether the audio segment has a higher priority responsive to determining that the audio segment is not new.

27. The method of claim 26, further comprising steps of:
determining whether all audio segments within the list of audio segments have been recorded; and
determining whether a highest priority for each audio segment within the list of audio segments has been obtained.

28. The method of claim 27, further comprising a step of receiving a signal representative of a request to manipulate the priority criteria.

29. The method of claim 24, further comprising a step of determining whether the audio segment is new.

30. The method of claim 29, further comprising a step of overwriting a recorded audio segment with the audio segment responsive to determining that the audio segment is not new.

31. The method of claim 24, further comprising a step of determining whether all audio segments within the list of audio segments have been recorded.

32. The method of claim 24, further comprising a step of receiving a signal representative of a request to manipulate the list of audio segments.

33. The method of claim 32, wherein the signal is representative of a request to manipulate the list of audio segments in one of: deleting an entry, adding an entry, and modifying an existing entry.

34. The method of claim 24, further comprising a step of automatically recording a second audio segment.

35. The method of claim 34, further comprising a step of storing the recorded audio segments in a predefined manner.

36. A system for recording an audio segment comprises:
a receiver configured to receive a broadcast signal, the broadcast signal including an encoded audio signal;
a decoder configured to decode the audio signal from the broadcast signal;
a storage device configured to store an audio segment of the audio signal;
a user interface configured to receive a list of audio segments from a user;
a controller configured to control the receiver, the decoder, and the storage device;
a processor, coupled to the controller, configured to automatically search the audio signal for the audio segment and to determine whether the audio segment matches an entry within the list of audio segments; and
an output device configured to output the audio segment.

37. The system of claim 36, wherein the receiver is configured to receive broadcast signals from a plurality of broadcast sources.

38. The system of claim 36, wherein the storage device is configured to store the audio segment responsive to a predetermined order.

39. The system of claim 36, wherein the user interface is remotely operated.

40. The system of claim 39, wherein the user interface is remotely operated by a cellular telephone.

41. A method for recording an audio segment comprising steps of:
automatically recording a current audio segment from a broadcast source;
determining whether the current audio segment matches an entry within a list of audio segments; and
automatically recording the entire current audio segment upon determining that the current audio segment matches, or, in the alternative, automatically stopping the recordation of the current audio segment upon determining that the current audio segment does not match.

42. The method of claim 41, further comprising a step of receiving a priority criteria

43. The method of claim 41, further comprising a step of determining whether all audio segments within the list of audio segments have been recorded.

44. The method of claim 41, further comprising a step of receiving a signal representative of a request to manipulate the list of audio segments.
